(19) United States
(12) Patent Application Publication
(10) Pub. No.: US 2022/0397271 A1
(43) Pub. Date: Dec. 15, 2022

(54) HINGED CHIMNEY CAP

(71) Applicant: Mark Stoner, Smyrna, TN (US)

(72) Inventor: Mark Stoner, Smyrna, TN (US)

(21) Appl. No.: 17/735,834

(22) Filed: May 3, 2022

Related U.S. Application Data
(60) Provisional application No. 63/183,584, filed on May 3, 2021.

(51) Int. Cl. F23J 13/08; E05F 1/12

(52) U.S. Cl. CPC F23J 13/08; E05F 1/1261; E05F 1/1223

(57) ABSTRACT

A hinged chimney cover apparatus includes a lid portion attached to a base portion via at least one hinge mechanism. Each hinge mechanism is integrated with a spring device configured to reduce the amount of force needed to open and close the lid. Additionally, by counterbalancing the weight of the lid with the torque of the spring, the lid is configured to remain stationary at certain open positions. This facilitates the ability of a user to easily access an interior portion of a chimney or flue to which the chimney cover apparatus is attached to perform maintenance or cleaning tasks therein.

### CROSS-REFERENCES TO RELATED APPLICATIONS

This application hereby claims priority to and incorporates by reference in its entirety U.S. Provisional Patent Application No. 63/183,584 entitled “HINGED CHIMNEY CAP” filed on May 3, 2021.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to apparatuses for covering chimneys. More particularly, this invention pertains to chimney caps.

Chimneys have been used for hundreds of years to facilitate the removal of smoke and gases from building interiors through an internal duct called a flue. To prevent water, debris, and small animals from entering the top opening of the flue while still allowing smoke and gases to escape, chimney covers or caps are used. A typical chimney cap is made of steel or copper and includes a top solid lid portion along with mesh sidewalls. The cap is securely mounted to the outside top portion of a chimney with screws, bolts, or other fasteners. This creates problems when the chimney requires maintenance work, such as to remove the buildup of creosote within the flue or to repair cracks or holes in the flue or chimney crown. Because the chimney cap has substantial weight, it is difficult and dangerous for a repair person to unmount the cap, maneuver and hold on to the cap, perform the necessary maintenance or repair work, and finally reinstall the cap, all while standing on a ladder or rooftop. These problems are compounded during windy or otherwise hazardous weather conditions.

### BRIEF SUMMARY OF THE INVENTION

Aspects of the present invention provide a chimney cover apparatus that includes at least one hinge mechanism that facilitates the movement of such chimney cover apparatuses between an open position and a closed position. The chimney cover apparatus includes a top solid lid portion configured to prevent water, debris, or small animals from entering a chimney by at least partially covering the chimney top or flue opening and a base portion configured below the lid portion, the base portion comprising a generally planar horizontal bottom frame and at least one sidewall extending upwardly from the frame, with the at least one sidewall including at least one opening for venting smoke or gas. In some aspects, the at least one sidewall may comprise a plurality of such openings, as in a mesh configuration, or the at least one sidewall may be completely open, comprising side posts and a top beam. The top of the at least one sidewall comprises a generally planar cross section. The frame has a cross section similar to the cross section of the chimney top. The lid portion is attached to the base portion with at least one hinge mechanism. One or more of the hinge mechanisms are configured with a spring device that provides an amount of torque to assist a user in moving the lid portion from a closed position to an open position, and vice versa. The bottom of the lid portion comprises a generally planar cross section. When the lid portion is in its closed position, the bottom of the lid portion is generally parallel to the top of the at least one base portion. The base portion is mountable to an upper portion of a chimney or flue via at least one fastener, such as a bolt or screw.

In one aspect, a chimney cover apparatus includes a top solid lid portion attached to a base portion via at least one hinge mechanism that comprises a spring device in the form of a torsion spring. The torsion spring is configured with a tension to reduce the amount of effort a user must exert while moving the lid portion from a closed position to an open position, and vice versa. A counterbalance relationship is achieved between the downward torque applied by the weight of the lid portion and the upward torque applied by the spring device such that below a certain balance angle formed by the bottom of the lid portion and the top of the at least one sidewall of the base portion, the torque applied by the lid portion will overpower the torque applied by the spring device and push the lid gently closed. Likewise, when the lid portion achieves an open position that is above the balance angle, the torque applied by the spring device will overpower the torque applied by the lid portion and gently push the lid portion to its maximum open position. At the balance angle, the amount of torque applied by the spring device substantially opposes the torque applied by the lid portion and the lid portion is maintained at a generally constant open position. In some nonlimiting exemplary embodiments, one or more protrusions may be integrated with one or more of the hinge mechanisms in order to limit the angle at which the lid portion may achieve in its maximum open position relative to its closed position.

In another aspect, a chimney cover apparatus includes a top solid lid portion attached to a base portion via at least one hinge mechanism that comprises at least one spring device in the form of an extension spring. Each extension spring is configured with a tension to reduce the amount of effort a user must exert while moving the lid portion from a closed position to an open position, and vice versa. A counterbalance relationship is achieved between the downward torque applied by the weight of the lid portion and the upward torque applied by the spring device such that the torque applied by the lid portion substantially opposes the torque applied by the spring device at all positions of the lid portion between open and closed, with compensation made for any internal friction experienced anywhere within the chimney cover apparatus, thereby maintaining the lid portion at any open position a user chooses. In some nonlimiting exemplary embodiments, the angle at which the lid portion may be opened relative to the lid portion's closed position may be limited by one or more protrusions integrated with one or more of the hinge mechanisms, or by the structure of the hinge mechanism(s).

In another aspect, a chimney cover apparatus includes a top solid lid portion attached to a base portion via at least one hinge mechanism that comprises at least one spring device, wherein the cross section of the base portion comprises a parallelogram, such as a rectangle. Each hinge mechanism comprises a housing with at least one aperture to attach it to the at least one sidewall of the base portion via one or more fasteners, such as studs, nails, screws, or bolts. The housing comprises a base and at least one sidewall extending outwardly from the base. In some aspects, the base and sidewall(s) may be generally planar and configured generally perpendicular to each other. Each hinge mechanism further comprises a pivot arm with at least one aperture to securely attach it to the lid portion by receiving one or more fasteners. The pivot arm is configured to rotate under the influence of at least one spring device along a lateral axis around an axle with a longitudinal axis that is generally perpendicular to the pivot arm's lateral axis of rotation. The longitudinal axis of the axle traverses the hinge mechanism housing. The spring device comprises a coiled portion and two free ends. The first end of the spring device is attached to the pivot arm and the second end of the spring device is attached to the housing. The hinge mechanism(s) may be configured anywhere along a base portion sidewall, such as at a center portion thereof or at a distal edge where two adjacent sidewalls meet at a side post.

In another aspect, a chimney cover apparatus includes a top solid lid portion attached to a base portion via at least one hinge mechanism, wherein an elongated rigid support member, such as a rod or bar, is configured to be removably attached to the base portion at a first distal end and removably attached to the lid portion at a second distal end by one or more notches, grooves, or recesses integrated with one or more sidewalls of the base portion or the base portion frame and the lid portion, particularly one or more outer edges thereof. In some nonlimiting exemplary embodiments, the support member may be permanently secured in a movable fashion to the base portion or lid portion at the first or second distal end, respectively, via one or more fastening elements such that the elongated member may be free to pivot in a two-dimensional plane, such as via a hinge, or in three dimensions, such as via a swivel hinge. While spanning the distance between its secured positions on the base and lid portions, the elongated support member maintains the lid portion at a fixed open position, which may be particularly useful during windy conditions. When not being used, the elongated support member may be stored within an elongated flange integrated with an elongated edge of the lid portion or a base portion.

### BRIEF DESCRIPTION OF THE SEVERAL VIEWS OF THE DRAWINGS

FIG. 1 is a front perspective view of a chimney cover apparatus in an open position, according to one embodiment of the invention.

FIG. 2 is a front perspective view of the chimney cover apparatus in a closed position.

FIG. 3 is a rear perspective view of the chimney cover apparatus in the close position.

FIG. 4 is a rear perspective view of the hinged chimney cover apparatus in the open position.

FIG. 5 is a rear perspective view of a hinge mechanism configured for use with the chimney cover apparatus, according to one embodiment of the invention.

FIG. 6 is a front perspective view of the hinge mechanism configured for use with the chimney cover apparatus.

FIG. 7 is a front perspective view of a hinge mechanism configured for use with the chimney cover apparatus, according to one embodiment of the invention.

FIG. 8 is a rear perspective view of the hinge mechanism configured for use with the chimney cover apparatus.

FIG. 9 is a front perspective view of a hinge mechanism configured for use with the chimney cover apparatus, according to one embodiment of the invention.

FIG. 10 is a rear perspective view of the hinge mechanism configured for use with the chimney cover apparatus.

FIG. 11A is a front perspective view of a fastening element configured to receive a first distal end of a support member for use with the chimney cover apparatus, according to one embodiment of the invention.

FIG. 11B is a front perspective view of a fastening element configured to receive a second distal end of the support member for use with the chimney cover apparatus.

FIG. 12 is a front perspective view of the chimney cover apparatus with the support member stored therein, according to one embodiment of the invention.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

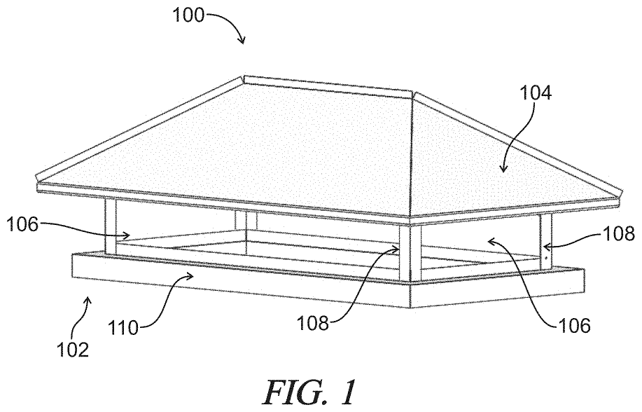

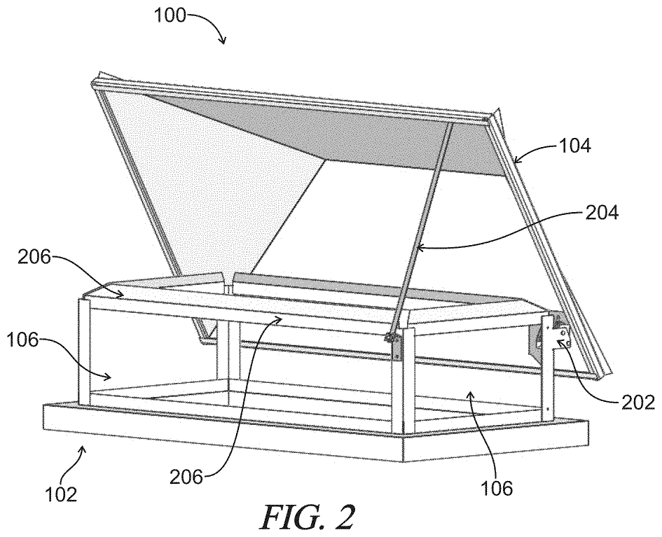

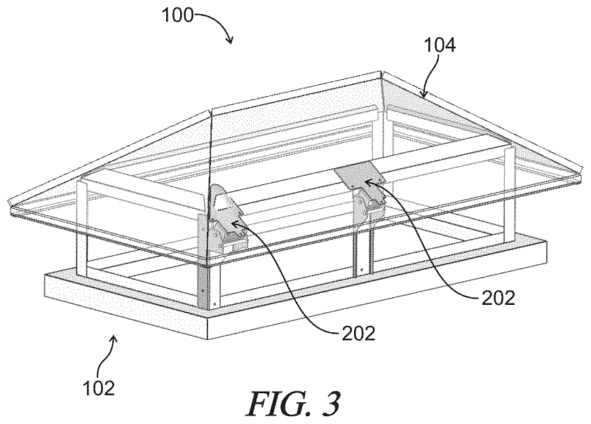

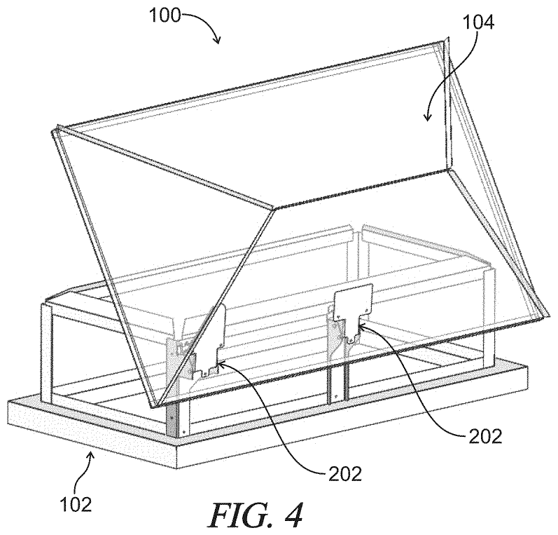

As described herein, an upright position is considered to be the position of apparatus components while in proper operation or in a natural resting position as described herein. As described herein, the upright position of the chimney cover apparatus is how the chimney cover apparatus would be oriented when properly installed on a chimney top, with the frame of the base portion in a generally horizontal orientation, such as shown in FIGS. 1-4. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment.

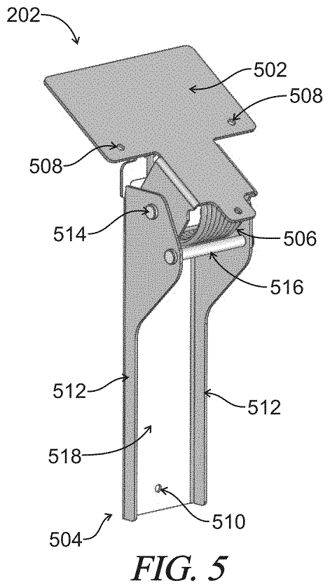

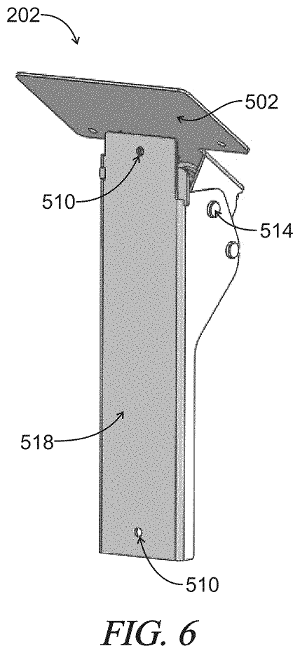

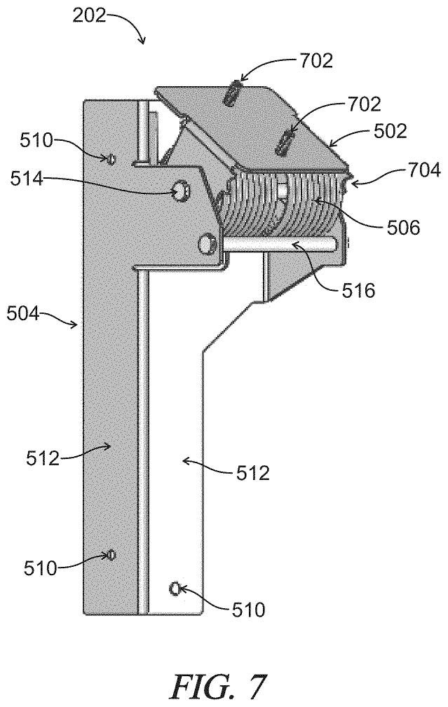

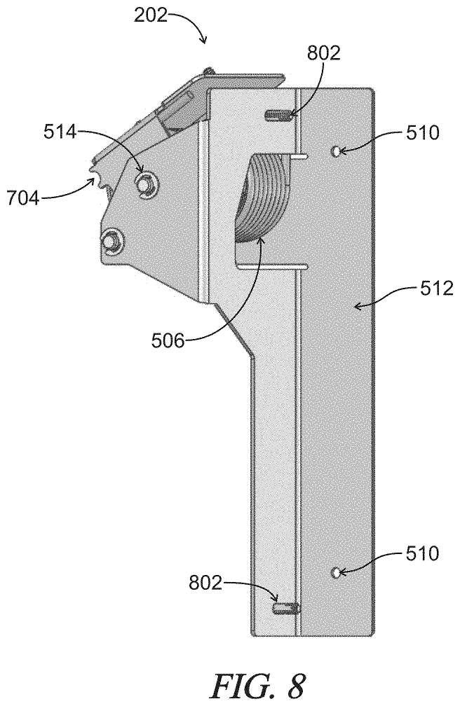

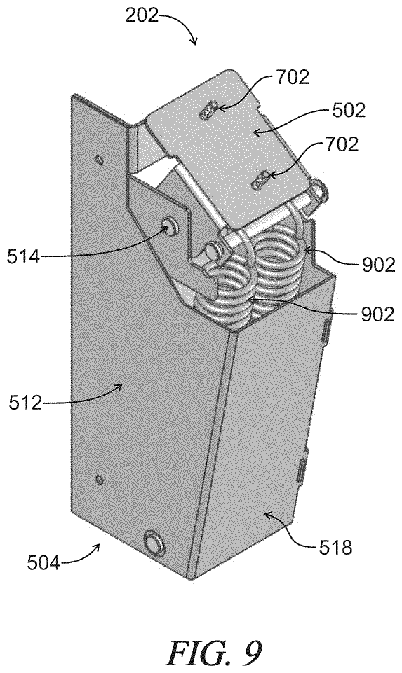

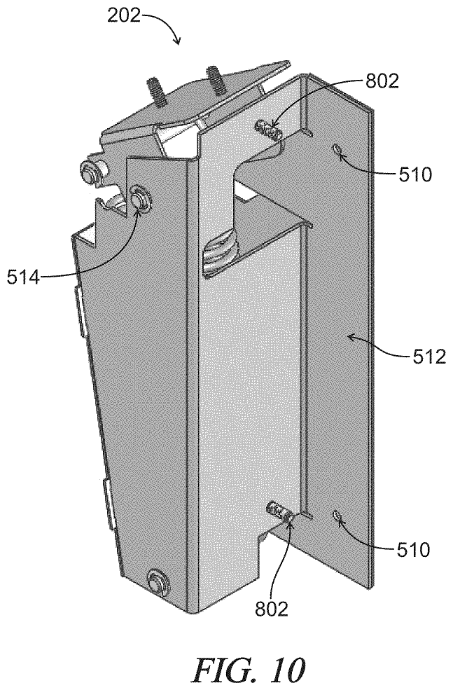

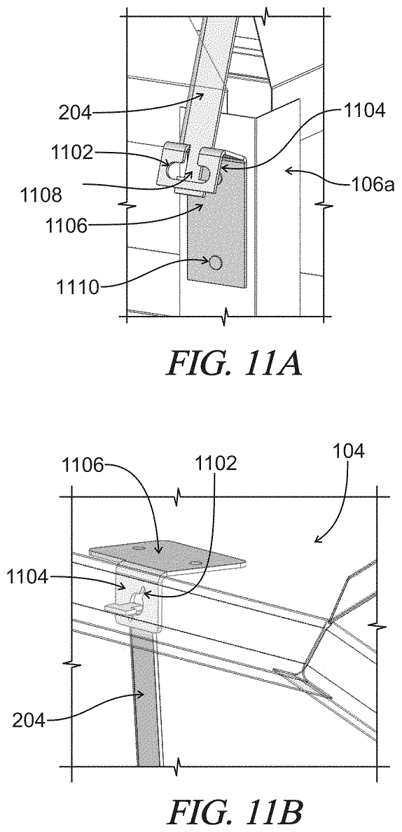

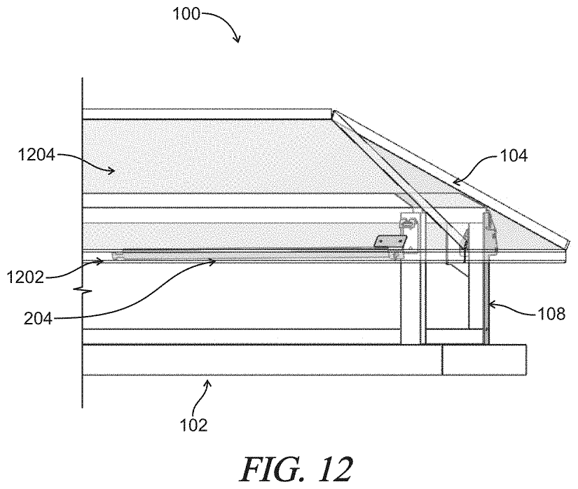

Referring now to FIGS. 1-12, a chimney cover apparatus 100 includes a base portion 102 connected to a top lid portion 104 via at least one hinge mechanism 202. The base portion 102 may comprise a generally planar horizontal frame 110 and at least one sidewall 106 extending upwardly therefrom when the chimney cover apparatus 100 is assembled on a chimney top in an upright position as shown at, for example, FIG. 1. The frame 110 may have a horizontal cross section substantially similar in size and shape to the cross section of a chimney top to which the frame 110 may be mounted. Each hinge mechanism 202 may include at least one spring device configured to reduce the amount of physical force needed to be applied by a user while moving the lid portion 104 (and the hinge mechanism 202) from a closed position to an opened position and vice versa. The lid portion 104 is configured above the base portion 102 to at least partially cover a chimney top. The lid portion 104 may comprise a substantially solid material, such as aluminum, copper, steel, or the like, or a combination of such materials, in order to prevent water, debris, or small animals from passing through the top of the chimney cover apparatus 100 when the lid portion 104 is in the closed position, wherein the bottom of the lid portion 104 is generally parallel to the top of the at least one sidewall 106 when the lid portion 104 and hinge mechanism 202 are in the closed position. In one embodiment, the lid portion 104 may comprise a peaked shape, such as a cone or pyramid, in order to prevent water or debris from building up on its top surface. In one embodiment, the lid portion 104 may weigh approximately 32 pounds and have a height of 15 inches, a width of 38.750 inches, and a length of 68.875 inches. In one embodiment, the bottom of the lid portion 104 and the top of the at least one sidewall 106 each have generally rectangular horizontal cross sections. By moving the lid portion 104 to an at least partially open position, the user may access an internal portion of a chimney or flue upon which the chimney cover apparatus 100 is mounted for maintenance or cleaning of the chimney or flue.

The base portion 102 may be configured in a variety of ways. For example, in one embodiment the base portion 102 may include four substantially vertical sidewalls 106 that are generally perpendicular relative to the frame 110 arranged as a parallelogram, such as a square or rectangle. In one embodiment, one or more sidewalls 106 may comprise a plurality of holes in a mesh configuration, whereas in another embodiment the sidewalls 106 may be completely open. In such embodiments, substantially solid posts 108 may be configured at corners where adjacent sidewalls 106 meet and top beams 206 may be configured as the top of sidewalls 106 joining the posts 108. Each sidewall 106, post 108, and beam 206 may comprise one or more materials similar to those that may be used for lid portion 104. The base portion 102 may be securely attached to the top of a chimney and/or flue using one or more fasteners, such as screws, bolts, studs, nails, and the like.

Each hinge mechanism 202 of the chimney cover apparatus 100 comprises a housing 504 and a pivot arm 502. The pivot arm 502 is configured to rotate relative to the housing 504 via an axle 514 that is contained within at least one portion of the pivot arm 502. In one embodiment, the axle 514 forms the pivot point for the hinge mechanism 202, and the housing 504 locates the axle 514 at an elevation below a top of the base 102 and spaced a predetermined distance from the base 102 which is less than an overhang of the lid 104 over the top of the base 102. That is, with the pivot point (i.e., axle 514) below and behind the lid 104, when the user opens the lid 104, the lid will rotate partially down and back from the user instead of directly upwards. The pivot arm 502 rotates along a lateral axis that is generally perpendicular to a longitudinal axis traversing lengthwise through the axle 514 (i.e., the longitudinal axis along which the axle 514 extends). The housing 504 comprises a substantially flat planar base 518 and at least one sidewall 512. In on embodiment, each sidewall 512 includes a substantially flat planar element configured generally perpendicular to the base 518 of housing 504. Distal ends of the axle 514 are received by opposing sidewalls 512 of housing 504. In one embodiment, the axle 514 may remain stationary as the pivot arm 502 rotates around it, while in another embodiment the axle 514 may rotate with the pivot arm 502. The pivot arm 502 may rotate under the influence of at least one spring device, wherein a first end of the spring device is attached to the pivot arm 502 and a second end of the spring device is attached to the housing 504. In one embodiment, the structural integrity of the housing 504 may be further enhanced by at least one support rod 516 configured generally parallel to the axle 514 and securely attached at its two distal ends by opposing sidewalls 512. In one embodiment, the pivot arm 502 comprises a standoff from the axle 514 with a groove 704 therein configured to contact and partially surround the support rod 516 in the fully open position in order to limit the maximum opening angle of the hinge mechanism 202 or lid portion 104. In one embodiment, a tension of the spring device and a distance between axle 514 and the point where the spring device mounts to the pivot arm 502 (or contacts the pivot arm 502) are selected in combination to counterbalance a weight of the lid portion 104. In one embodiment, the hinge mechanism 202 comprises a plurality of attachment points for the spring device to attach to the pivot arm 502 such that the torque of the hinge mechanism 202 can be adjusted to match a weight of the lid portion 104.

The housing 504 of a hinge mechanism 202 may be securely attached to the base portion 102 of a chimney cover apparatus 100 using one or more fasteners 802 configured to be received by corresponding apertures 510 in the housing 504 into the base portion 102. The housing 504 may be configured so that the hinge base 518 and hinge sidewall(s) 512 fit tightly around one or more sides of a post 108 of the base portion 102. Similarly, the pivot arm 502 of the hinge mechanism 202 may be securely attached to the lid portion 104 of the chimney cover apparatus 100 by one or more fasteners 702 received by corresponding apertures 508 in the pivot arm 502 into the lid 104. In embodiment, the pivot arm 502 may comprise a generally flat portion configured to fit tightly against a generally flat surface of the lid portion 104. The pivot arm 502 may be glued or welded to the lid 104 in some embodiments. By way of example and not limitation, fasteners 802 and 702 may include studs, nails, bolts, screws, rivets, or the like. By way of further example and not limitation, fasteners 702 and 802 may comprise two ¼-20 studs (such as the PEM® brand available from PennEngineering of Danboro, Pa.).

In one embodiment, each spring device used with the chimney cover apparatus 100 may include a torsion spring 506. Each torsion spring 506 is configured with a tension to apply an amount of upward torque (i.e., torque tending to move the hinge mechanism 202 and the lid portion 104 toward the open position) that counterbalances the amount of downward torque (i.e., torque tending to move the hinge mechanism 202 and the lid portion 104 toward the closed position) applied by the weight of the lid portion 104. As the lid portion 104 is moved to various open positions (i.e., positions between fully closed and fully or maximally opened), the bottom of the lid portion 104 forms an angle relative to the top of each sidewall 106 that comprises the base portion 102. At a certain angle, called the balance angle, the amount of upward torque applied by the torsion spring(s) 506 substantially opposes the amount of downward torque applied by weight of the lid portion 104, thereby causing the lid portion 104 to remain in a generally constant open position when not acted on by any other outside forces. When the lid portion 104 is in a position below the balance angle, the downward torque applied by the weight of the lid portion 104 is greater than the upward torque applied by the torsion spring(s) 506 and the lid portion 104 is pushed to its closed position by the weight of the lid portion 104, at which the angle formed between the bottom of the lid portion 104 and the top of each sidewall 106 is approximately zero degrees. The upward torque applied by the torsion spring(s) 506 prevents the lid portion 104 from merely slamming shut. In one embodiment, less than 10 pounds of force (e.g., 1 pound of force) is required at an edge of the lid portion 104 opposite the hinge mechanism 202 to dislodge the lid portion 104 from the closed position. In a similar fashion, when the lid portion 104 is at a position above the balance angle, the upward torque applied by the torsion spring(s) 506 is greater than the downward torque applied by the weight of the lid portion 104 and the lid portion 104 is pushed to its maximum open position by the torque applied by the spring mechanism. By way of example and not limitation, the torsion spring(s) 506 may be configured so that the balance angle is approximately 42 degrees and a user would need to apply approximately one pound of force to move the lid portion 104 up to the balance angle from closed or down to the balance angle from open.

In one embodiment, each spring device used with the chimney cover apparatus 100 may comprise an extension spring 902. Each extension spring 902 is configured with a tension to apply an amount of upward torque that counterbalances the amount of downward torque applied by the weight of the lid portion 104. The extension spring(s) 902 may be configured so that when the lid portion 104 is opened to form any angle between the bottom of the lid portion 104 and the top of the sidewall(s) 106 of the base portion 102, the upward torque applied by extension spring(s) 902 substantially opposes the downward torque applied by the weight of the lid portion 104, thereby maintaining the lid portion 104 at any open position (i.e., position between fully closed and fully opened) it may be placed, with compensation made for any internal friction within the hinge mechanism 202 or any other part of the chimney cover apparatus 100. In this configuration, the lid portion 104 may be moved by applying less than one pound of force. In one embodiment, the spring device includes a combination of torsion springs and extension springs. In one embodiment, support rod 516 extends through corresponding apertures in the standoffs of the pivot arm 502, and the extension springs mounts between the support rod 516 in the standoffs of the pivot arm and a second support rod mounted through sidewalls 512 of the housing 504 at a bottom of the housing 504. The sidewalls 512 of the housing include a groove for contacting the support rod 516 and limiting travel (and thus the maximum opening angle) of the pivot arm 502.

In one embodiment, the chimney cover apparatus 100 may further comprise at least one substantially rigid elongated support member 204, such as a rod or bar. The support member 204 comprises two distal ends that may be configured to be removably received by the base portion 102 and the lid portion 104 so that the support member 204 may function to physically maintain the lid portion 104 at a constant open position. The distal ends of the support member 204 may be removably secured in place by interacting with one or more fastening elements such as grooves, slots, notches, detents, protrusions, ridges, or the like. By way of example and not limitation, the distal ends of support member 204 may comprise tapered neck segments 1108, each of which may be configured to be removably secured within a slot 1102 comprised within a protruding tab 1104 extending outwardly from a baseplate 1106. One baseplate 1106 may be secured to the base portion 102, such as to a sidewall 106 or post 108, while another baseplate 1106 may be secured to the lid portion 104. The baseplates 1106 may be secured using one or more fasteners 1110, such as screws, bolts, nails, and the like. In one embodiment, one of the distal ends may be permanently affixed to the base portion 102 or the lid portion 104. In such embodiment, the permanently affixed end of the support member 204 may be integrated with a movable structure, such as a hinge or swivel hinge, thereby enabling the support member 204 to pivot or rotate about the affixed location. When not in use, the support member 204 may be stored within an elongated flange 1202 or similar structure, such as a lip, tray, or collar. Elongated flange 1202 may be configured, for example, near the bottom of an inner surface 1204 of the lid portion 104 or within an interior portion of the base portion 102.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful HINGED CHIMNEY COVER APPARATUS it is not intended that such references be construed as limitations upon the scope of this invention except as set forth in the following claims.

What is claimed is:

1. A chimney cover apparatus comprising:
a base portion configured to be secured to a chimney top, said chimney top having an opening therein for venting gases therefrom;
a lid portion configured secure to the base portion such that the lid is positioned over the opening in the chimney top when the chimney cover apparatus is assembled on the chimney top;
and
a hinge mechanism connecting the lid portion to the base portion when the chimney cover apparatus is assembled on the chimney top, said hinge mechanism having a closed position wherein the lid portion covers the opening in the chimney top to substantially prevent water ingress in to the opening in the chimney and an open position wherein the lid portion is not covering the opening in the chimney to allow a technician access to the opening in the chimney top.

2. The chimney cover apparatus of claim 1, wherein:
the base portion comprises:
a generally planar horizontal frame with a cross section similar to the cross section of the chimney top; and
at least one sidewall extending upwardly from the frame, said sidewall having a top with a generally planar cross section;
the lid portion is configured to at least partially cover the chimney top, said lid portion comprising a bottom with a generally planar cross section; and
the hinge mechanism comprises a housing attached to the base portion and a pivot arm attached to the lid portion, the hinge mechanism is configured to enable the lid portion to rotate around a longitudinal axis traversing the hinge mechanism between the open position and the closed position, and the closed position comprises a position at which the bottom of the lid portion is generally parallel to the top of the at least one sidewall.

3. The chimney cover apparatus of claim 2, wherein:
the hinge mechanism housing comprises a base and at least one sidewall extending outwardly from the base.

4. The chimney cover apparatus of claim 3, wherein:
the hinge mechanism housing sidewall and the hinge mechanism housing base are generally planar and the hinge mechanism housing sidewall extends generally perpendicular from the housing base.

5. The chimney cover apparatus of claim 2, wherein:
the chimney cover apparatus further comprises at least one spring device.

6. The chimney cover apparatus of claim 5, wherein:
the hinge mechanism further comprises a pivot arm configured to attach to the lid portion of the chimney cover apparatus when the chimney cover apparatus is assembled on the chimney top; and
the at least one spring device comprises a first end and a second end, wherein the first end of the at least one spring device is attached to the hinge mechanism pivot arm and the second end of the at least one spring device is attached to the hinge mechanism housing such that the spring device counterbalances the weight of the lid portion as hinge mechanism is moved from the closed position to the open position.

7. The chimney cover apparatus of claim 2, wherein:
the chimney cover apparatus further comprises at least one spring device;
the hinge mechanism further comprises a pivot arm configured to attach to the lid portion of the chimney cover apparatus when the chimney cover apparatus is assembled on the chimney top; and
the at least one hinge mechanism further comprises an axle extending along a longitudinal axis, wherein the hinge mechanism pivot arm rotates around the axle along a lateral axis that is generally perpendicular to the longitudinal axis of the axle.

8. The chimney cover apparatus of claim 5, wherein:
the at least one spring device comprises a torsion spring.

9. The chimney cover apparatus of claim 7, wherein:
the at least one spring device comprises a torsion spring;
the torsion spring is selected to have a tension configured to counterbalance the weight of the lid portion such that when the hinge mechanism is between the closed position and open position, the lid portion is at a balanced open position at which an amount of torque applied to the pivot arm of the hinge mechanism about the axle by the weight of the lid portion is opposite and in direction and approximately equal to an amount of torque applied by the torsion spring to the pivot arm, and a balance angle is formed by the bottom of the lid portion and a top beam of the at least one sidewall of the base portion; and
when the hinge mechanism is rotated to a position by movement of the lid portion such that that the angle formed by the bottom of the lid portion and the top beam of the at least one sidewall of the base portion is greater than the balance angle, the lid portion is forced by the spring device to the open position of the hinge mechanism, and when the lid portion is moved to an open position at which the angle formed by the bottom of the lid portion and the top of the at least one sidewall of the base portion is less than the balance angle, the lid portion is moved by the weight of the lid to the closed position of the hinge mechanism.

10. The chimney cover apparatus of claim 9, wherein:
the balance angle is between 20 and 50 degrees;
less than 10 pounds of force is required at an edge of the lid portion opposite the hinge mechanism to move the lid portion from the closed position of the hinge mechanism to the balanced open position and from the balanced open position to the open position of the hinge mechanism; and
the balance angle is approximately 42 degrees and approximately one pound of force is required to move the lid portion from the closed position to the balanced open position and from the maximum open position to the balanced open position.

11. The chimney cover apparatus of claim 7, wherein:
the chimney cover apparatus further comprises at least one spring device; and
the at least one spring device comprises an extension spring.

12. The chimney cover apparatus of claim 11, wherein:
the extension spring is selected to have a tension configured to counterbalance the weight of the lid portion such that at any position between closed and open, an amount of torque applied to the hinge mechanism by the weight of the lid portion substantially opposes a direction and amount of torque applied by the extension spring, thereby causing the lid portion to remain stationary when the hinge mechanism is set to any position between closed and open without application of any other forces to the lid or hinge mechanism.

13. The chimney cover apparatus of claim 12, wherein:
less than 5 pounds of force applied to an edge of the lid portion opposite the hinge mechanism moves the hinge mechanism from the closed position to the open position or from the open position to the closed position; and
less than 1 pound of force applied to the edge of the lid portion opposite the hinge mechanism moves the hinge mechanism form the closed position to the open position or from the open position to the closed position.

14. The chimney cover apparatus of claim 2, wherein:
the at least one hinge mechanism further comprises at least one protrusion extending outwardly from at least one of: the housing or the pivot arm;
the at least one protrusion is configured to stop the at least one hinge mechanism from moving beyond a maximum open position at which a maximum open angle is formed by the bottom of the lid portion and the top of the at least one sidewall of the base portion.

15. The chimney cover apparatus of claim 14, wherein:
the maximum open angle is between about 25 and 65 degrees; and
the maximum open angle is one of: 30 degrees or 60 degrees.

16. The chimney cover apparatus of claim 2, wherein:
the hinge mechanism housing comprises at least one aperture configured to receive at least one fastener to attach the housing to the base portion and the hinge mechanism pivot arm comprises at least one aperture configured to receive at least one fastener configured to attach the pivot arm to the lid portion.

17. The chimney cover apparatus of claim 16, wherein:
the at least fastener comprises at least one of: a screw, a stud, a nail, and a bolt.

18. The chimney cover apparatus of claim 17, wherein:
the at least one fastener comprises a ¼-20 stud.

19. The chimney cover apparatus of claim 2, wherein:
the chimney cover apparatus further comprises an elongated support member configured to be removably secured at a first distal end to the lid portion and removably secured at a second distal and to the base portion.

20. The chimney cover apparatus of claim 19, wherein:
at least one of: the first distal end or the second distal end of the elongated support member is permanently secured to at least one of: the lid portion or the base portion; and
the elongated support member is configured to be stored within an elongated flange integrated with at least one of: the lid portion or the base portion.
